(19) United States
(12) Patent Application Publication
(10) Pub. No.: US 2006/0186735 A1
(43) Pub. Date: Aug. 24, 2006

(54) Method for monitoring a hydro-electrical brake system

(75) Inventors: Thorsten Ullrich, Gernsheim (DE); Stefan Feick, Kirchheimboladen (DE); Jens Lerchenberger, Vienenburg (DE)

Correspondence Address: Craig Hallacher;Continental Teves Inc, One Continental Drive, Auburn Hills, MI, 48326, US

(73) Assignee: Continental Teves AG & Co., oHG

(21) Appl. No.: 10/564,003

(22) PCT Filed: Jul. 8, 2004
(86) PCT No.: PCT/EP04/51410

§ 371 Date: Jan. 9, 2006

(30) Foreign Application Priority Data
Jul. 8, 2003 (DE) 10330663.3

(51) Int. Cl. B60T 8/88

(52) U.S. Cl. 303/122.14; 303/122.08

(57) ABSTRACT

A method to prevent injury to a person carrying maintenance work on a brake system is disclosed. During standstill without pedal appication, a brake system having a high-pressure accumulator with an active pressure build-up my clamp on a worker. In order to prevent this danger, the electronic control associated with charging operation of the high-pressure accumulator is deactivated and the separating valve associated with a vehicle axel is closed. Inlet valves associated with the vehicle axle are opened to displace pressure fluid into the wheel brakes while determining values representing the hydraulic pressure introduced into the wheel brakes. The values are evaluated to judge the condition of the wheel brakes.

### BACKGROUND OF THE INVENTION

The present invention relates to a method for monitoring an electrohydraulic brake system for a motor vehicle, with a master brake cylinder (2) operable by means of a brake pedal (1), with a travel simulator (3) cooperating with the brake pedal (1), with at least one pressure source actuatable by an electronic regulation and control unit (16) which is formed of a high-pressure accumulator (21) that can be charged by means of a pump (23), and the pressure of the pump can be applied to wheel brakes (7, 8) of the vehicle which are connectable to the master brake cylinder (2), on the other hand, by means of at least one hydraulic connection (5) that can be closed by means of a separating valve (11), with a device (33) for detecting the driver's deceleration request, and with each one inlet valve (17, 18 connected upstream of the wheel brakes (7, 8) and an outlet valve (27, 28).

A brake system of this type is disclosed in the applicant's international patent application WO 99/41125. In electrohydraulic brake systems of this type it is required to actively adjust wheel brake pressures without the driver applying the brake pedal, in particular within the limits of self tests and system calibrations during vehicle standstill. Examples for this case are the so-called pre-drive check executed prior to starting to drive upon activation of the brake system (wake-up e.g. by way of the remote control of the central locking system or the door switch), or cleansing and calibrating routines which take place after the ignition has been switched off.

The active pressure buildup during standstill without pedal application represents a risk potential if maintenance works at the brake system are simultaneously carried out (danger of a person being clamped in). Although it is possible to take the legal aspect (product liability) into account by issuing warning notices, e.g. in the vehicle handbook and in the workshop instructions, it is desirable that the system has an intelligence on its own in order to rule out at least serious injuries of the workshop staff.

### SUMMARY OF THE INVENTION

In view of the above, an object of the invention is to disclose an appropriate method of monitoring the above-mentioned brake system, the implementation of the method eliminating the risks of injury.

According to the invention, this object is achieved by the following process steps:
deactivating an electronic control associated with the charging operation of the high-pressure accumulator and carried out by the electronic regulation and control unit;
closing the separating valve associated with a vehicle axle;
opening the inlet valves associated with the vehicle axle for the purpose of displacing pressure fluid volume into the wheel brakes of the vehicle axle, while additionally determining values representative of the hydraulic pressure introduced into the wheel brakes and the displacement of pressure fluid volume; and
evaluating the values for judging the condition of the wheel brakes.

According to a favorable feature of the method of the invention, the displacement of pressure fluid volume into the wheel brakes, with the high-pressure accumulator charged, takes place in that the inlet valves connected upstream of the wheel brakes are partly opened and the reduction of the pressure fluid volume contained in the high-pressure accumulator is taken into consideration as an indicator of the displacement of pressure fluid volume into the wheel brakes.

An alternative embodiment of the method of the invention involves that the displacement of pressure fluid volume into the wheel brakes, with the high-pressure accumulator discharged, takes place as a result of actuation of the pump, and the inlet valves connected upstream of the wheel brakes are opened to full extent, and the indicator of the displacement of pressure fluid volume into the wheel brakes is produced by numerical integration of the pump volume flow.

Another favorable feature of the method of the invention includes that the values representing the hydraulic pressure and the displacement of pressure fluid volume are compared with previously defined threshold values, and the results of the comparison are subjected to a time pressure/volume correlation.

Another favorable improvement of the method of the invention involves that a condition is concluded from the fact of an increase of the hydraulic pressure introduced into the wheel brakes in excess of the previously defined threshold value, during which the indicator of the displacement of pressure fluid volume does not reach the threshold value associated with the volume, in which condition the friction elements of the wheel brakes are applied to their associated friction surfaces.

If, in another favorable improvement, the indicator of the displacement of pressure fluid volume exceeds the (volume) threshold value and the hydraulic pressure introduced into the wheel brakes does not reach the (pressure) threshold value, an inadmissible displacement travel of pistons provided in the wheel brakes is concluded, representing an imminent risk to the maintenance staff during maintenance works at the wheel brakes.

Finally, an optical or an acoustic warning is issued upon detection of the inadmissible displacement travel of the pistons according to another favorable feature of the method of the invention.

### BRIEF DESCRIPTION OF THE DRAWINGS

The invention will be explained in detail in the following description of an embodiment making reference to the accompanying drawings. In the drawings:

FIG. 1 is a schematic view of an electrohydraulic brake system wherein the method of the invention can be implemented;

FIG. 2 shows a flow chart illustrating the sequence of the method of the invention;

FIG. 3 shows a first pressure/volume correlation to be performed during the method of the invention, and

FIG. 4 shows a second pressure/volume correlation to be performed during the method of the invention.

### DETAILED DESCRIPTION OF THE DRAWINGS

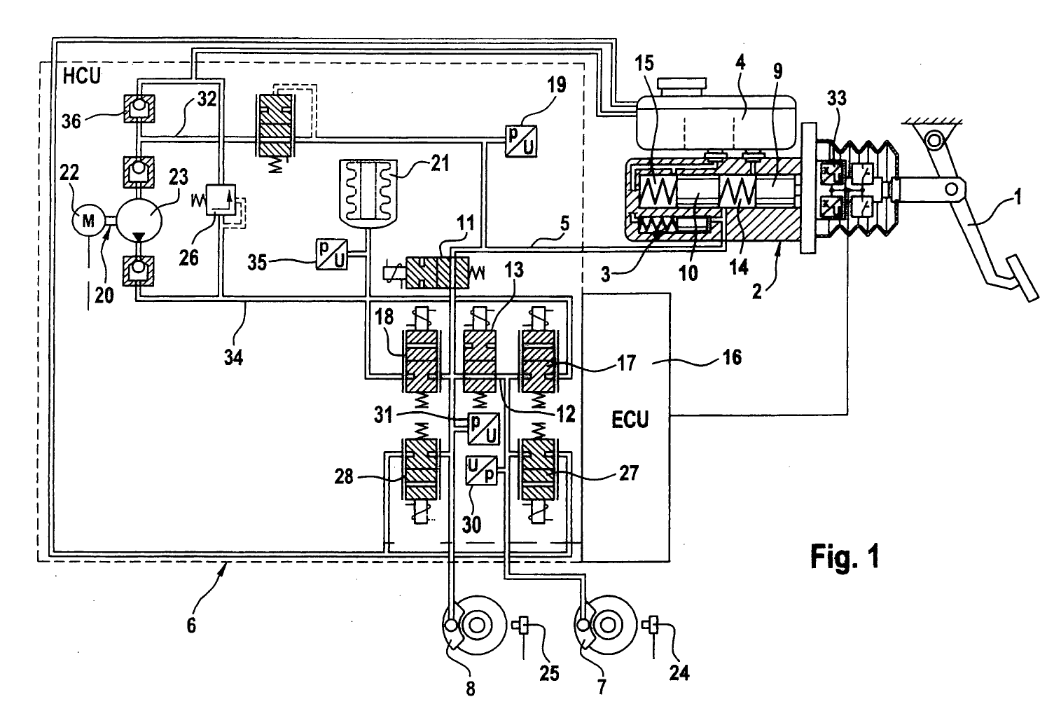

The brake system which is only represented in FIG. 1 is essentially composed of a dual-circuit hydraulic pressure generator or master brake cylinder 2 in a tandem design which is operable by means of a brake pedal 1, a travel simulator 3 cooperating with the tandem master cylinder 2, a pressure fluid supply reservoir 4 associated with the tandem master cylinder 2, a hydraulic pressure source, a control unit HCU 6 which is only represented and comprises, among others, all components necessary for pressure control operations and to which e.g. wheel brakes 7, 8 are connected that are associated with the rear axle of the motor vehicle, as well as an electronic regulation and control unit ECU 16. Wheel sensors 24, 25 (only indicated) are used to determine the rotational speed of the vehicle wheels. The per se known tandem master cylinder 2 includes two isolated pressure chambers 14, 15 which are limited by two pistons 9, 10 and are connectable both to the pressure fluid supply reservoir 4 and, through the HCU 6, also to the vehicle brakes 7, 8, -, -. The other brake circuit is not shown, to which the wheel brakes associated with the front axle are connected. The above-mentioned pressure source is formed of a high-pressure accumulator 21 which is charged by means of a pump 23 of a motor-and-pump assembly 20. Pump 23 is driven by an electric motor 22, and the output pressure of the pump 23 is limited by a pressure-limiting valve 26 that is connected in parallel to the pump 23. A pressure sensor 35 monitors the hydraulic pressure provided by the high-pressure accumulator 21.

As can further be taken from FIG. 1, the wheel brakes 7, 8 are connected to the first pressure chamber 14 by means of a conduit 5 in which a separating valve 11 is inserted which is configured as a normally open (NO) two-way/two-position directional control valve and permits closing the first pressure chamber 14. A second hydraulic conduit 34 connects the pressure side of the pump 23 or the high-pressure accumulator 21 to the inlet connections of two electromagnetically operable, preferably normally closed (NC) two-way/two-position directional control valves of analog operation or inlet valves 17, 18, respectively, which are connected upstream of the wheel brakes 7 and 8. Another pair of likewise electromagnetically operable, preferably normally closed (NC) two-way/two-position directional control valves of analog operation or outlet valves 27, 28, respectively, allow a connection between the wheel brake 7, 8 and the pressure fluid supply reservoir 4, while an electromagnetically operable, preferably normally open (NO) pressure compensating valve 13 allows a wheel-individual control of the pressures introduced into the wheel brakes 7, 8.

Further, pressure sensors 30, 31 are associated with the wheel brakes 7, 8 and used to determine the hydraulic pressure that prevails in the wheel brakes 7, 8. The above-mentioned electronic control and regulation unit ECU 16 to which are sent the output signals of the pressure sensors 19, 30, 31, 35, of the wheel speed sensors 24, 25, and of a preferably redundantly designed brake request detection device 33, which latter is associated with the master brake cylinder 2, is used to actuate the motor-and-pump assembly 20 and the above-mentioned valves 11, 13, 17, 18, 27, 28.

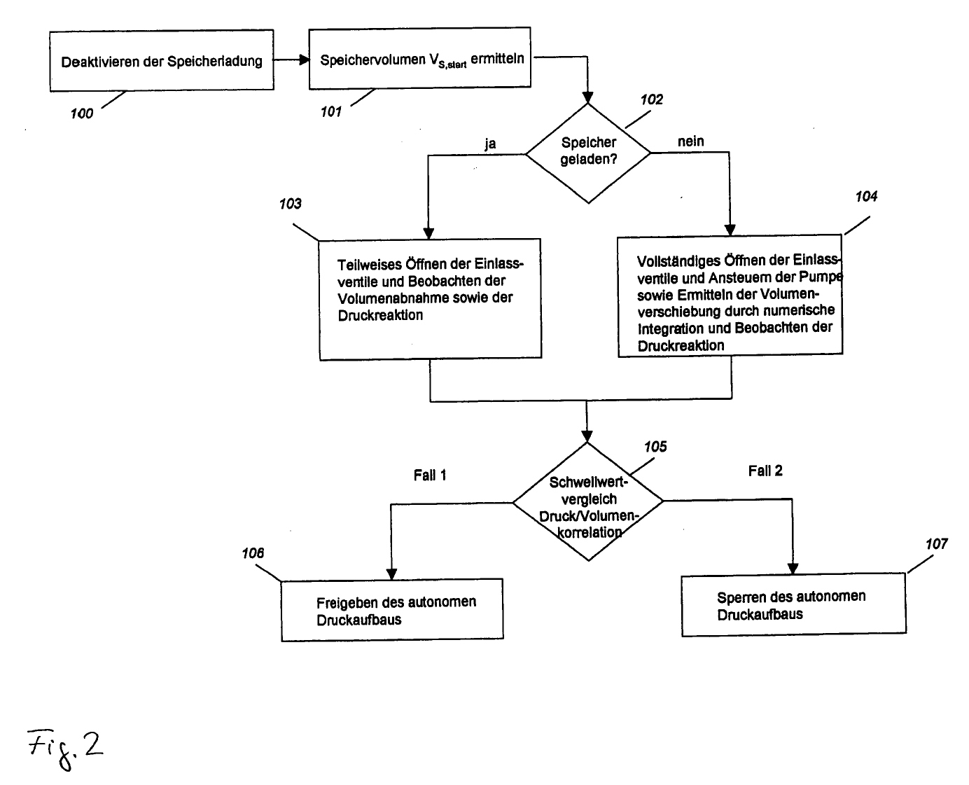

As has already been referred hereinabove, the basic idea of the invention involves detecting an inadmissibly long displacement travel of the wheel brake pistons prior to an active pressure build-up. A wheel brake piston that is pushed back extremely far indicates maintenance works at the brake system. In this case, it is possible only in such an extreme brake piston position that fingers of a person working at the wheel brake are placed between the brake lining and brake disc. It can be seen in the flow chart shown in FIG. 2 that the charging operation of the high-pressure accumulator 21 (process step 100) is deactivated when the method of the invention is implemented, whereupon in a second process step 101 the pressure fluid volume V_{S,start} of the high-pressure accumulator 21 is determined. It is subsequently found out in a third process step (102) whether the high-pressure accumulator 21 is charged or discharged. When the high-pressure accumulator 21 is charged, pressure fluid is conducted into the wheel brakes 7, 8 by partly opening the inlet valves 17, 18 connected upstream of the wheel brakes 7, 8 in process step 103. As this occurs, the reduction of the pressure fluid volume contained in the high-pressure accumulator 21 is taken as an indicator of the displacement of pressure fluid into the wheel brakes 7, 8.

When the high-pressure accumulator 21 is discharged, however, pressure fluid volume is conducted by way of actuation of the pump 23 and complete opening of the inlet valves 17, 18 connected upstream of the wheel brakes 7, 8 (process step 104). In this case, the indicator of the pressure fluid volume displacement is obtained by numerical integration of the pump volume flow.

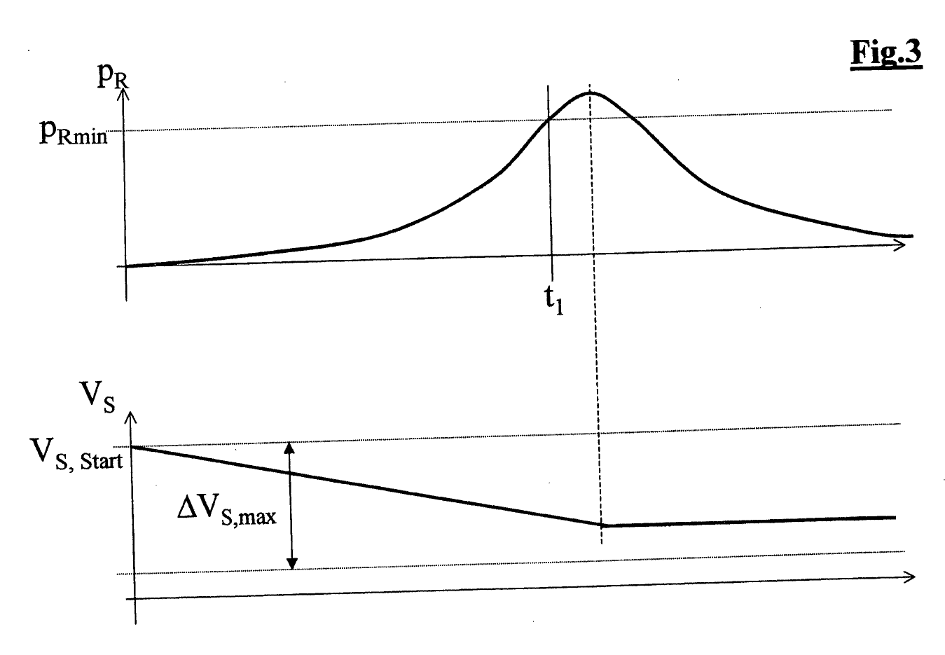

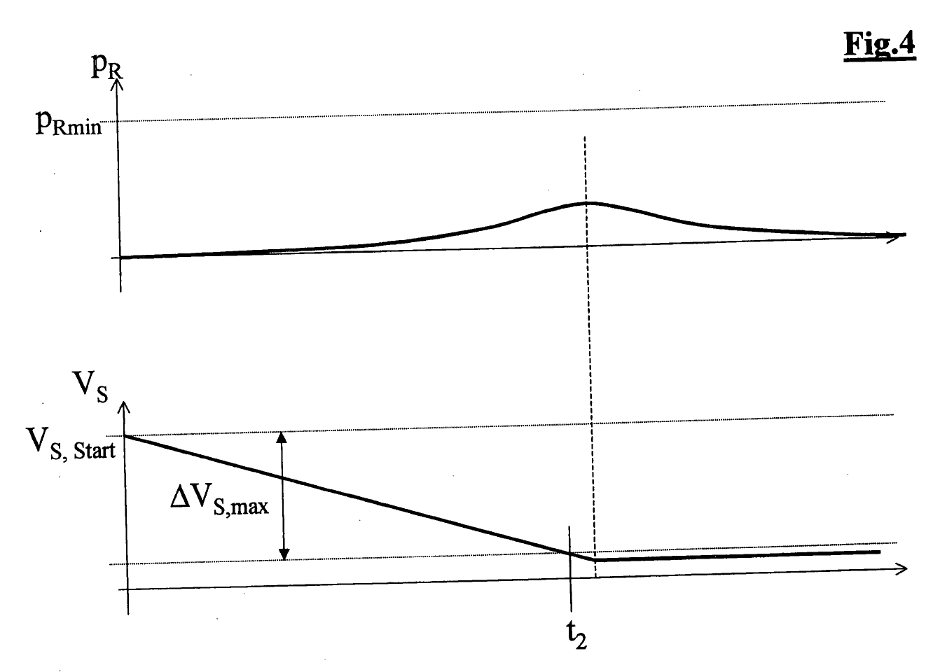

In this procedure, the pressure p_{R} in the wheel brakes 7, 8 rises, while the indicator of the pressure fluid volume displacement grows. In process step 105, these signals are compared with previously determined threshold values p_{R,min}, ΔV_{S,max} and subjected to a time correlation. As becomes apparent from the flow chart, two results of this comparison are possible, which are illustrated in FIGS. 3 and 4 for the case of the pressure fluid volume displacement out of the high-pressure accumulator 21:
1. When the hydraulic pressure introduced into the wheel brakes 7, 8 rises in excess of the previously determined threshold value (p_{Rmin}) at time t₁ (FIG. 3) without the reduction of the pressure fluid volume contained in the high-pressure accumulator 21 reaching the (volume reduction) threshold value ΔV_{S,max}, a condition is concluded in which the friction elements of the wheel brakes 7, 8 are applied to their associated friction surfaces. Active build-up of the hydraulic pressure introduced into the wheel brakes 7, 8 can be carried out without any risk in this case (see FIG. 2—process step 106).
2. When, in contrast thereto, the reduction of the pressure fluid volume contained in the high-pressure accumulator 21 drops at the time t2 (FIG. 4) below the (volume reduction) threshold value ΔV_{Smax} without the hydraulic pressure introduced into the wheel brakes 7, 8 reaching the (pressure) threshold value p_{Rmin}, an inadmissible displacement travel of pistons provided in the wheel brakes 7, 8 is concluded. There is an extreme position of the pistons in this case, with the result of an imminent risk of injury to workshop staff carrying out maintenance works at the wheel brakes. An active build-up of the hydraulic pressure introduced into the wheel brakes 7, 8 is then omitted (see FIG. 2—process step 107) and recovered at a later point of time (e.g. upon the next system start).

The volume threshold value V_{Smax} is determined in such a fashion that a safe detection is safeguarded, with the given accuracy of the provided sensor system for finding out the volume reduction. On the other hand, this threshold value is used to define the maximum displacement travel of a wheel brake piston until detection of the extreme position.

While calibration routines for optimizing the system qualities or cleansing processes serving for the system's robustness can be postponed to a later point of time without serious losses in functions when an extreme brake piston position is detected, the following problem is encountered with respect to the so-called pre-drive-check:

Fault conditions such as leakage or the existence of large quantities of air or gas in the brake system, which shall be detected by the pre-drive check, present themselves in terms of the above-mentioned signals exactly as an extreme brake piston position does. Therefore, it may be appropriate (question of the safety and warning concept) to initially assume a system fault when an extreme brake piston position is detected prior to the pre-drive check and trigger an alarm for the driver (warning lamp or the like). When it shows in subsequent braking operations initiated by the driver that the brake system is intact, the alarm can be eliminated.

1-8. (canceled)

9. A Method of monitoring an electrohydraulic brake system for motor vehicle, having a master brake cylinder (2) operable by a brake pedal (1), a travel simulator (3) cooperating with the brake pedal (1), at least one pressure source actuatable by an electronic regulation and control unit (16) which is formed of a high-pressure accumulator (21) that can be charged by means of a pump (23), and the pressure of the pump can be applied to wheel brakes (7, 8) of the vehicle which are connectable to the master brake cylinder (2), on the other hand, by means of at least one hydraulic connection (5) that can be closed by means of a separating valve (11), with a device (33) for detecting the driver's deceleration request, and with each one inlet valve (17, 18 connected upstream of the wheel brakes (7, 8) and an outlet valve (27, 28), the method comprising:
deactivating an electronic control associated with a charging operation of a high-pressure accumulator and carried out by an electronic regulation and control unit;
closing a separating valve associated with a vehicle axle,
opening inlet valves associated with the vehicle axle for the purpose of displacing pressure fluid volume into wheel brakes of the vehicle axle, while determining values representative of a hydraulic pressure introduced into the wheel brakes and a displacement of pressure fluid volume; and
evaluating the values to judge the condition of the wheel brakes.

10. The method according to claim 9, wherein the displacement of pressure fluid, with the high-pressure accumulator charged, takes place by partly opening the inlet valves and in the reduction of the pressure fluid volume contained in the high-pressure accumulator is taken into consideration as an indicator of the displacement of pressure fluid.

11. The method according to claim 9, wherein the displacement of pressure fluid into the wheel brakes, with the high-pressure accumulator discharged, takes place as a result of actuation of the pump and complete opening of the inlet valves.

12. The method according to claim 11, wherein the displacement of pressure fluid is approximated by numerical integration of the pump volume flow within the electronic control unit.

13. The method according to claim 12, wherein values representing the hydraulic pressure and the displacement of pressure fluid volume are compared with previously defined threshold values and the results of the comparison are subjected to a time pressure/volume correlation.

14. The method according to claim 13, wherein a condition is concluded from an increase of the hydraulic pressure introduced into the wheel brakes in excess of the previously defined threshold value, during which the indicator of the displacement of pressure fluid does not reach the threshold value, in which condition the friction elements of the wheel brakes are applied to their associated friction surfaces.

15. The method according to claim 14, the indicator of the displacement of pressure fluid exceeds the threshold value and the hydraulic pressure introduced into the wheel brakes does not reach the threshold value, an inadmissible displacement travel of pistons provided in the wheel brakes is concluded, representing an imminent risk to maintenance staff during maintenance works at the wheel brakes.

16. A method according to claim 15, an optical or an acoustic warning is issued upon detection of the inadmissible displacement travel of the pistons.
